(19) United States
(12) Patent Application Publication
(10) Pub. No.: US 2021/0086447 A1
(43) Pub. Date: Mar. 25, 2021

(54) VENT PLUGS

(71) Applicant: HEWLETT-PACKARD DEVELOPMENT COMAPNY, L.P., Spring, TX (US)

(72) Inventors: David C. Harvey, Corvallis, OR (US); Brad Benson, Corvallis, OR (US)

(21) Appl. No.: 16/603,378

(22) PCT Filed: Oct. 5, 2017
(86) PCT No.: PCT/US2017/055389

§ 371 Date: Oct. 7, 2019

(51) Int. Cl. B29C 64/255; B33Y 30/00

(52) U.S. Cl. CPC B29C 64/255; B33Y 30/00

(57) ABSTRACT

Example systems relate to a hydrophobic material vent plug for a build material container. In one example, a vent plug can include a hydrophobic material that includes a one or more pores to allow a gas to travel from a first end of the vent plug to a second end of the vent plug, and the hydrophobic material to repel liquid from the one or more of pores.

### BACKGROUND

Additive manufacturing techniques, such as three-dimensional (3-D) printing, can manufacture objects through deposition of successive layers of build material onto a build surface. Build material may be deposited onto the build surface. Portions of the build material may then be selectively solidified, and the process may be repeated until the 3-D object is fully manufactured.

### BRIEF DESCRIPTION OF THE DRAWINGS

FIG. 1 is an example of a hydrophobic vent plug that includes a plurality of pores consistent with the present disclosure.

FIG. 2 is an example of a system for a build material container with a vent plug consistent with the present disclosure.

FIG. 3 is an example of a build material container with a vent plug consistent with the present disclosure.

FIG. 4 is a top view of build material container with a vent plug consistent with the present disclosure.

### DETAILED DESCRIPTION

A number of systems and devices for build material container with a vent plug are described herein. In some examples, a vent plug can include a hydrophobic material that includes a plurality of pores to allow a gas to travel from a first end of the vent plug to a second end of the vent plug, and the hydrophobic material to repel liquid from the plurality of pores.

In some examples, the hydrophobic material that includes a plurality of pores may allow a gas to travel from a first end of the vent plug to a second end of the vent plug. In some examples, the hydrophobic vent plug may be positioned on the base of the build material container to allow a gas to travel from the interior portion of the build material container to an exterior portion of the build material container. For example, the hydrophobic vent plug can be utilized to equalize atmospheric pressure between the interior portion of the build material container and the exterior portion of the build material container.

Additive manufacturing devices such as 3D printers can utilize a build material that has a powdered and/or granular form, such as plastic, ceramic, and metals powders or powder-like materials. The 3D printer may apply build material in successive layers in a build area to selectively solidify, for example by melting and fusing, portions of the build material to create layers of 3D objects. The process may be repeated to generate 3D objects in a layer-by layer manner. In some examples, the build material can be selected by applying a fusing, or energy absorbing, agent on portions of the build material to be fused and applying a fusing energy to each layer of build material.

As used herein, the term “3D printer” can, for example, refer to a device that can create a physical 3D object. In some examples, the 3D printer can create the 3D object utilizing a 3D digital model. In other examples, a 3D printer can create the 3D object utilizing powder bed fusion, among other types of 3D printing. For example, a 3D printer can utilize powder bed fusion by combining a fusing agent with the build material such that the fusing agent absorbs heat from a heat source in order to melt, fuse, and solidify the build material in order to create a 3D object.

Build material can be, for example, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered, powder-type, or particulate material. In some examples, build material can be a thermally or light reflective material. The build material can be a reflective material to maintain the temperature of the build material relatively cooler than build material with deposited fusing agent.

A build material container can be utilized to store build material and/or transport quantities of build material from a first location to a second location. For example, build material containers can be utilized to store a particular type of build material for retail sale. In some examples, the build material container may have an internal pressure change due to altitude and/or atmosphere variation while storing and/or transporting the build material container. In some examples, a vent plug can be utilized to avoid damage caused to the structure of the build material container by the internal pressure change. For example, an internal pressure change or external pressure change of the build material container can cause the build material container to expand or contract, which can alter a shape of the build material container. In some examples, the altered shape of the build material container can permanently or semi-permanently damage the build material container.

In some examples, the vent plug can be utilized to equalize pressure between the internal side of the build material container and an exterior side of the build material container. In this way, a change to the interior pressure or exterior pressure of the build material container is not able to alter the shape of the build material container.

In some examples, the vent plug can be made of a hydrophobic material that can prevent moisture from blocking a plurality of pores of the vent plug that allow the pressure to equalize. For example, moisture can build up around the pores of the vent plug and prevent air molecules from being able to pass from an interior portion of the build material container to the exterior portion of the build material container. In this example, a hydrophobic material can prevent the moisture from entering the build material container and prevent buildup around the pores of the vent plug.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure, In addition, the proportion and the relative scale of the elements provided in the figures are intended to illustrate the examples of the present disclosure, and should not be taken in a limiting sense.

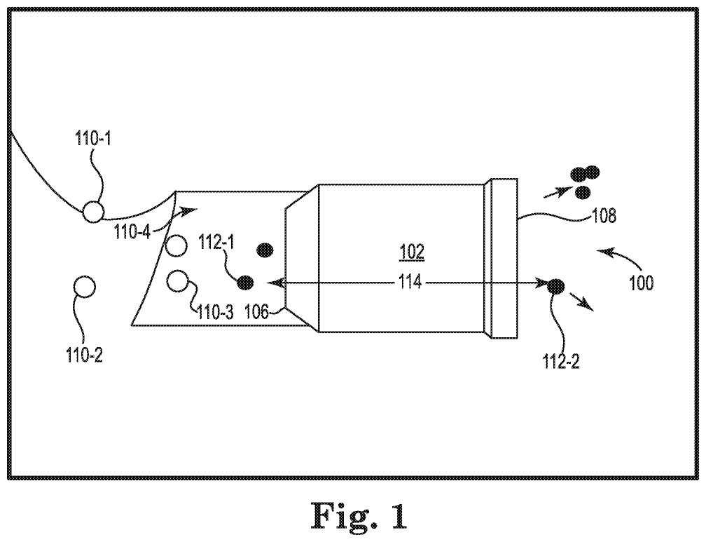

FIG. 1 is an example of a hydrophobic vent plug 100 that includes a plurality of pores consistent with the present disclosure. In some examples, the vent plug 100 can be utilized for equalizing a pressure within a build material container for an additive manufacturing system. For example, the vent plug 100 can be positioned within an aperture between the inside and the outside of a build material container to equalize pressure within the build material container. The range of pressure difference, caused by vent plug 100, when inserted, can be 1494.5 Pascals (Pa) to 11209.0 Pa before and 1494.5 Pascals (Pa) to 14945.0 Pa after. In some examples, the vent plug 100 can include a plurality of pores 114. The plurality of pores 114 can be a particular diameter to allow a gas 112-1, 112-2 to pass from a first side 106 of the vent plug 100 to a second side 108 of the vent plug 100 without allowing build material 110-1, 110-2, 110-3 to pass from the first side 106 to the second side 108. In this way, the pressure from the first side 106 of the vent plug 100 can be equalized with the second side 108 of the vent plug 100.

In other examples, 114 can be a channel to allow a gas 112-1, 112-2 to pass from a first side 106 of the vent plug 100 to a second side 108 of the vent plug 100 without allowing build material 110-1, 110-2, 110-3 to pass from the first side 106 to the second side 108.

In some examples, the vent plug 100 can be made of a hydrophobic material. As used herein, hydrophobic material refers to the property of a material that repels water. For example, a hydrophobic material can be a material that has an absence of an attraction to water and therefore appears to repel the water from a surface or area of the hydrophobic material. In some examples, the vent plug 100 can be made completely of a hydrophobic material. In other examples, the vent plug 100 can comprise a first portion that is made of a hydrophobic material and a second portion that comprises a different material. For example, the portion of the vent plug that includes the plurality of pores 114 can be manufactured from hydrophobic material to repel moisture from blocking one or more of the plurality of pores 114.

In some examples, hydrophobic material may include oils, fats, alkanes, and most other organic compounds. In another example, hydrophobic material may be silica and/or titanium dioxide. For example, the vent plug 100 can comprise a titanium dioxide material that includes a plurality of pores 114. In this example, the vent plug 100 can be shaped from the titanium dioxide material to fit within an aperture of a build material container. In this example, the plurality of pores 114 can be formed through the shaped titanium dioxide so that the hydrophobic material is lining the plurality of pores 114. In this way, the plurality of pores 114 can dispel moisture from either surface edge or surface within the plurality of pores.

In some examples, the plurality of pores 114 can be coated with a hydrophobic material. For example, the vent plug 100 can be shaped from a non-hydrophobic material and the plurality of pores 114 can be coated with a hydrophobic material to dispel moisture from the plurality of pores as described herein. Thus, the vent plug 100 can comprise a first portion that includes a first material and a second portion that includes a second material that is a hydrophobic material.

In some examples, the vent plug 100 can be positioned within an aperture of a build material container. As illustrated in FIG. 1 examples, the vent plug 100 can include a first side 106, and a second side 108. The first side 106 can be positioned in the interior portion of the build material container. The second side 108 can be positioned on the exterior portion of the build material container. In some examples, the second side 108 can be exposed to the exterior portion of the build material container at a base of the build material container. In some examples, the plurality of pores 114 can allow air molecule 112-1 and 112-2 to travel through the vent plug but not allow the build material 110-1, 110-2, 110-3 to escape the interior portion of the build material container.

In some examples, the vent plug 102 can be compressible between a first side 106 and a second side 108. For example, the vent plug 102 can be compressed on a first edge that is illustrated as a top edge in FIG. 1 and on a second edge that is illustrated as a bottom edge in FIG. 1. In some examples, a pore diameter of the plurality of pores 114 can alter when the vent plug 102 is compressed within an aperture of the build material container. In some examples, the pore diameter of the plurality of pores 114 are altered to an active pore diameter when the hydrophobic material is compressed within the aperture of the build material container. In some examples, the average pore diameter of the active pore diameter of the plurality of pores 114 are below 7 microns. In some examples, the pore diameter of the plurality of pores 114 can be greater than 7 microns prior to being compressed to the active pore diameter.

As described herein, the build material powder particles 110-1, 110-2, 110-3, 110-4 can have a size that is greater than 7 microns of average diameter. Thus, the plurality of pores 114 can prevent the build material from exiting the build material container while allowing the gas 112-1, 112-2 to pass through the vent plug 100. In some examples, the vent plug can be cylindrical in shape with a tapered portion on the first end 106 and a stopping portion on the second end 108.

The cylindrical shape of the vent plug 100 and tapered portion of the first end 106 can mechanically fit in an aperture. For example, the diameter of the vent plug 100 can be relatively larger than a diameter of the aperture of the build material container. In this example, the tapered portion of the first end 106 can be utilized to press fit the vent plug 100 into the aperture of the build material container. In some examples, the stopping portion or lip portion of the vent plug 100 on the second side 108 can be utilized to prevent the vent plug 100 from being pushed completely through the aperture of the build material container. For example, the stopping portion of the vent plug 100 can have a diameter that is greater than the cylindrical portion of the vent plug and a diameter that prevents the vent plug 100 from being pressed completely through the aperture of the build material container when the vent plug 100 is press fit into the aperture. As used herein, press fit includes when a first part (e.g., vent plug 100) is forced under pressure into an aperture (e.g., aperture of the build material container).

In some examples, the internal pressure of the sealed build material container may be different from the external pressure of the build material container. In one example due to a change in altitude, the internal pressure of the build material container may create a force on the surface of the build material container. As described herein, the force on the surface of the build material container can deform or damage the build material container. The vent plug 100 may be utilized to equalize the internal pressure by passing gas molecules 112-1 and 112-2 from the first end 106 of the vent plug 100 to the second end 108 of the vent plug 100. Additionally, the vent plug 100 can be positioned such that the vent plug 100 does not interfere with a functionality of the build material container. For example, the vent plug 100 can be positioned at a base of the build material container and may not be accessible when the build material container is coupled to the additive manufacturing system as described herein.

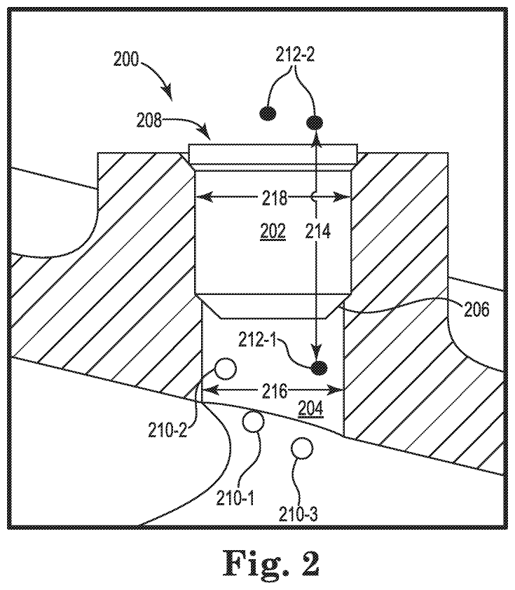

FIG. 2 is an example of a system for a build material container 200 with a vent plug 202 consistent with the present disclosure. In some examples, the vent plug 202 functions to equalize a pressure difference between the inside of a build material container and the outside of the build material container. In some examples, the vent plug 202 can include a plurality of pores 214. The plurality of pores 214 can be a particular diameter to allow a gas 212-1, 212-2 to pass from a first side 206 to a second side 208 of the vent plug 202 without allowing build material 210-1, 210-2, 210-3 to pass from the first side 206 to the second side 208 of the vent plug 202. In this way, the pressure from the first side 206 of the vent plug 202 can be equalized with the second side 208 of the vent plug 202.

In some examples, the build material container 200 can include an aperture 204 with an interior diameter 216. As illustrated in FIG. 2, the vent plug 202 can be positioned within aperture 204 of the build material container 200. The vent plug 202 can include a first side 206, and a second side 208. The first side 206 can be positioned in the interior portion of the build material container 200. The second side 208 can be positioned on the exterior portion of the build material container 200. In some examples, the second side 208 can be exposed to the exterior portion of aperture 204 at a base of the build material container 200, In some examples, the plurality of pores 214 can allow air molecule 212-1 and 212-2 to travel through the vent plug 202 but not allow the build material 210-1, 210-2, 210-3 to escape the interior portion of the build material container 200.

In some examples, the interior diameter 218 of vent plug 202 may be larger than the interior diameter 216 of aperture 204. For example, the vent plug 202 with diameter 218 can be compressible between a first side 206 and a second side 208. For example, the vent plug 202 can be compressed on a first edge that is illustrated as a right edge in FIG. 2 and on a second edge that is illustrated as a left edge in FIG. 2.

In some examples, a pore diameter of the plurality of pores 214 can alter when the vent plug 202 is compressed within aperture 204 of the build material container 200. In some examples, the average pore diameter of the plurality of pores 214 can be 7 micron when the vent plug 202 is compressed within the aperture 204. In some examples, the pore diameter of the plurality of pores 214 can be greater than 7 micron prior to being compressed to into the aperture 204. The degree of compression is calculated such that when installed, the vent plug has pores with a predetermined diameter.

As described herein, the build material 210-1, 210-2, 210-3, 210-4 can have a smallest particle size greater than 7 microns. Thus, the plurality of pores 214 can prevent the build material 210-1, 210-2, 210-3, 210-4 from exiting the build material container while allowing the gas 212-1, 212-2 to pass through the vent plug 202.

In some examples, vent plug 202 can be cylindrical in shape with a tapered portion on the first end 206 and a stopping portion on the second end 208. The cylindrical shape of the vent plug 202 and tapered portion of the first end 206 can mechanically fit in an aperture 204. For example, diameter 218 of the vent plug 202 can be relatively larger than diameter 216 of the aperture 204. In this example, the tapered portion of the first end 206 can be utilized to press fit the vent plug 202 into the aperture 204 of the build material container 200. In some examples, the stopping portion or lip portion of the vent plug 202 on the second side 208 can be utilized to prevent the vent plug 202 from being pushed completely through the aperture 204 of the build material container 200. For example, the stopping portion of the vent plug 202 can have a diameter that is greater than the diameter 218 of the cylindrical portion of the vent plug 202 and the diameter 216 of the aperture to prevent the vent plug 202 from being pressed completely through the aperture 204 of the build material container 200 when the vent plug 202 is press fit into the aperture 204. As used herein, press fit includes when a first part (e.g., vent plug 202) is forced under pressure into an aperture (e.g., aperture 204 of the build material container 200).

In some examples, the internal pressure of the build material container 200 may be different from the external pressure of the build material container. In one example, due to a change in altitude, the internal pressure of the container 200 may create a force on the surface of the build material container 200. As described herein, the force on the surface of the build material container can deform or damage the build material container 200.

In some examples, the vent plug 202 may function to equalize the internal pressure by passing gas 212-1 and 212-2 from the first end 206 the second end 208 of the vent plug 202. Additionally, the vent plug 202 can be positioned such that the vent plug 202 does not interfere with a functionality of the build material container 200. For example, the vent plug 202 can be positioned at a base of the build material container 200 and may not be accessible when the build material container 200 is coupled to the additive manufacturing system as described herein.

In some examples, the vent plug 202 can be positioned within an aperture 204 of the build material container to equalize pressure within the build material container. In some examples, the vent plug 202 can include a plurality of pores 214. The plurality of pores or channel 214 of the vent plug 202 can be a particular diameter to allow a gas 212 to pass from an interior portion of the build material container to an exterior portion of the build material container without allowing build material to pass from the interior portion to the exterior portion. In this way, the pressure from the interior portion of the build material container can be equalized with the exterior portion the build material container.

In some examples, the vent plug 202 may function to equalize the internal pressure by passing gas 212 from the first end to the second end of the vent plug 202. Additionally, the vent plug 202 can be positioned such that the vent plug 202 does not interfere with a functionality of the build material container. For example, the vent plug 202 can be positioned at a base of the build material container and may not be accessible when the build material container is coupled to the additive manufacturing system via the threaded portion as described herein.

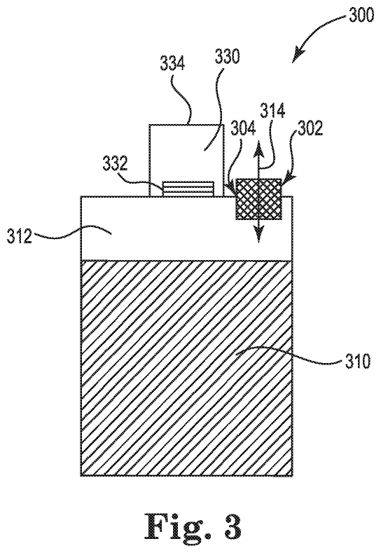

FIG. 3 is an example of a build material container 300 with a vent plug 302 consistent with the present disclosure. In some examples, the build material container 300 may comprise a container to store build material 310. The vent plug 302functions to equalize a pressure within the build material container 310. In some examples, the vent plug 302 can be made of a hydrophobic material. In other examples, vent plug 302 can comprise a first portion that includes a first material and a second portion that includes a second material that is a hydrophobic material. In some examples, the vent plug 302's diameter can range between 5 and 6 millimeter. In some examples, the vent plug 302 can be positioned within an aperture 304 of the build material container 300 to equalize pressure within the build material container 300. In some examples, the vent plug 302 can include a plurality of pores 314. The plurality of pores 314 of the vent plug 302 can be a particular diameter to allow a gas 312 to pass from an interior portion of the build material container 300 to an exterior portion of the build material container 300 without allowing build material 310 to pass from the interior portion to the exterior portion. In this way, the pressure from the interior portion of the build material container 300 can be equalized with the exterior portion the build material container 300. Build material particle size can be below 50 micrometers or 150 micrometers.

In some examples, the build material container can include an aperture 330 that can be utilized to dispense the build material 310 from the build material container 300. In some examples, the aperture 330 can include a threaded portion 332. The threaded portion 332 can be utilized to block the aperture 330 with a cap 334. In some examples, the cap 334 can seal the build material container 300. Since the build material container 300 is sealed by the cap 334, the vent plug 302 can be utilized to equalize the pressure within the build material container 300. In some examples, the threaded portion 332 can be utilized to couple the build material container 300 to an additive manufacturing system such as a 3D printing device.

In some examples, the vent plug 302 may function to equalize the internal pressure by passing gas 312 from the first end to the second end of the vent plug 302. Additionally, the vent plug 302 can be positioned such that the vent plug 302 does not interfere with a functionality of the build material container 300. For example, the vent plug 302 can be positioned at a base of the build material container 300 and may not be accessible when the build material container 300 is coupled to the additive manufacturing system via the threaded portion 332 as described herein.

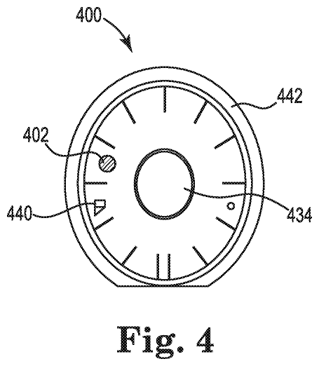

FIG. 4 is an example of build material container 400 with a vent plug 402 consistent with the present disclosure. In some examples, FIG. 4 can illustrate a base portion of the build material container 400. As used herein, a base portion of the build material container 400 can be a portion that can be coupled to an additive manufacturing system such as a 3D printing device.

In some examples, the build material container 400 can include an aperture for dispensing build material for an additive manufacturing system. As described herein, the aperture for dispensing build material can be sealed by a cap 434. In some examples, a microprocessor 440 can be located near the aperture for dispensing build material so that the microprocessor 440 can be utilized when the build material container 400 is coupled to the additive manufacturing system. For example, the additive manufacturing system can include a reader device to receive information from the microprocessor 440 when the build material container 400 is coupled to the additive manufacturing system.

In some examples, the microprocessor 440 can indicate a status of build material inside the build material container 400. For example, the build material container 400 can be coupled to a 3D printing device and the 3D printing device can determine a type of build material stored by the build material container 400. In some examples, the microprocessor 440 can be protected by a lip 442 of the build material container 400 when the build material container 400 is coupled to the additive manufacturing device. For example, the lip 442 can cover the microprocessor 440 when a threaded portion of the build material container 400 is coupled to a 3D printing device. In some examples, the lip 442 can also protect the vent plug 402 in a similar way when the threaded portion of the build material container 400 is coupled to an additive manufacturing device. For example, the lip 442 can be flush with a surface of the additive manufacturing device when the build material container 400 is coupled to the additive manufacturing device.

In some examples, the lip 442 can prevent access to the vent plug 402 and/or the microprocessor 440 when the build material container 400 is coupled to the additive manufacturing system. For example, the lip 442 can prevent a user from accessing the vent plug 402 when the build material container 400 is coupled to the additive manufacturing system. In some examples, preventing a user from accessing the vent plug 402 can prevent a user from adding build material to the build material container 400 when the build material container 400 is coupled to an additive manufacturing system.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense, Further, as used herein, “a number of” an element and/or feature can refer to any number of such elements and/or features.

What is claimed:

1. A vent plug, comprising:
a hydrophobic material that includes a one or more pores to allow a gas to travel from a first end of the vent plug to a second end of the vent plug; and
the hydrophobic material to repel liquid from the plurality of pores.

2. The vent plug of claim 1, wherein the hydrophobic material is compressible between a first side and a second side.

3. The vent plug of claim 1, wherein a pore diameter of the plurality of pores are altered when the hydrophobic material is fitted within an aperture of a container.

4. The vent plug of claim 3, wherein when compressed the pore diameter of the one or more pores are reduced below 7 micron.

5. The vent plug of claim 3, wherein the pore diameter of the one or more of pores are altered to an active pore diameter when the hydrophobic material is compressed within the aperture of the container.

6. The vent plug of claim 1, wherein the vent plug has a generally cylindrical shape with a stopping portion on a first end.

7. The vent plug of claim 1, wherein the hydrophobic material comprises at least one of silica and titanium dioxide.

8. A container, comprising:
an aperture of a first diameter;
a hydrophobic porous vent plug of a second diameter, wherein the first diameter of the aperture alters the hydrophobic porous vent plug when the second diameter is smaller than the first diameter; and
a plurality of pores of the hydrophobic porous vent plug to allow a gas to enter and exit the container, wherein the hydrophobic material prevents moisture from blocking the plurality of pores.

9. The container of clam 8, wherein the hydrophobic porous vent plug is positioned on a base of the container.

10. The container of clam 8, wherein the aperture alters a pore diameter of the plurality of pores to prevent build material from escaping the aperture.

11. The container of clam 8, wherein the hydrophobic material prevents a liquid from interacting with build material within the container and blocking the plurality of pores.

12. The container of clam 8, wherein the vent plug equalizes the internal pressure and external pressure of the container.

13. A system, comprising:
a build material container that includes a first aperture on an end of the build material container to couple to a three-dimensional (3D) printing device; and
a second aperture of the build material container on the end of the build material container to receive a hydrophobic porous vent plug that includes a plurality of pores to allow a gas to pass through the hydrophobic porous vent plug and prevents build material from exiting the second aperture, wherein the second aperture adjusts a pore diameter of the plurality of pores when the hydrophobic porous vent plug is inserted into the second aperture.

14. The system of claim 13, wherein the build material comprises a particle size below 50 micrometers or 150 micrometers.

15. The system of claim 13, wherein the second aperture is inaccessible when the first aperture is coupled to the 3D printing device.
